(19) United States
(12) Patent Application Publication
(10) Pub. No.: US 2017/0307155 A1
(43) Pub. Date: Oct. 26, 2017

(54) LED FIXTURE HAVING BUILT IN CAPABILITY FOR BATTERY BACKUP

(71) Applicant: Brian Brandes, Plainview, NY (US)

(72) Inventor: Brian Brandes, Plainview, NY (US)

(73) Assignee: SATCO PRODUCTS, INC.

(21) Appl. No.: 15/151,889

(22) Filed: May 11, 2016

Related U.S. Application Data
(63) Continuation-in-part of application No. 62/326,378, filed on Apr. 22, 2016.

(51) Int. Cl. F21S 9/02; F21S 8/00; F21S 8/04; F21V 23/02

(52) U.S. Cl. CPC F21S 9/022; F21V 23/023; F21S 8/033; F21S 8/04

(57) ABSTRACT

A device for a battery backup system comprising: a Lighting fixture; an LED light source, the LED light source accepting the battery backup system. The battery backup system comprising batteries, an indicator light and a test button, battery compartment access covers, and battery compartments. The batteries feed an inverter to run the LED light source. The battery system is plugged into the light source.

### RELATED APPLICATIONS

The present application is related to Provisional application Ser. No. 62/326,378 filed Apr. 22, 2016.

### FIELD OF THE INVENTION

The present invention relates to a fixture having built in capability for battery backup.

### BACKGROUND OF THE INVENTION

US patent publication 2012/0262093 relates to a lighting system comprising a lighting source, a connector in electrical communication with the lighting source and an external power source, an energy storage device, an input device and a controller. Embodiments disclose a battery backed LED lighting, a traffic signal may be constructed containing an internal battery backup, charging circuitry, connection to external power for normal operation and charging and the intelligence to switch over to battery backup and continue operation in the event of a power outage. The battery backed LED traffic signal may continue operation as prior to the outage for example by continuing cycling between red, yellow and green based on the timing previously used.

US patent publication 2015/0296599 relates to a modular coordinated lighting system comprising one or more wireless lighting devices that can communicate over a network and coordinate their operation to provide illumination to an area. In embodiments of emergency wireless lighting devices, a system may be created including a battery Backed LED Driver Module for LED fixtures containing a connection to external power, an integrated power source, a wireless receiver and the capability to drive the LED light source and a power outage module containing a power outage detector to detect a disruption in power and a wireless transmitter such that the power outage module may control the light source powered by the battery Backed LED Driver Module via the power outage module. In embodiments, a system may be created including a power outage module and a battery Backed Ballast with a wireless receiver to perform the functions for fluorescent lighting.

US patent publication 2015/0282261 relates to an autonomous shifting of at least a portion of a lighting load off an energy distribution grid. In an embodiment of a wireless emergency lighting system, the battery powered wireless lighting fixtures consists of an RF ceiling light and an RF nightlight that are off grid and may receive transmission from a power outage module that contains an RF transmitter, plugs into a wall outlet and directly monitors AC power such that a detected condition that would require a switchover to emergency lighting, such as a power outage or disruption in power, would initiate a transmission to the RF ceiling light and RF nightlight to turn them on.

US patent publication 2015/0163867 relates to a power management system for a lighting circuit that includes a grid shifting controller that includes a processor and a connection to an external power source. In embodiments, a wireless emergency lighting system may be controlled by a power outage module. In such an embodiment, battery powered wireless lighting fixtures containing a wireless receiver may be controlled by a power outage module such that upon detecting a disturbance in the power input, the power outage module may transmit a command to any number or type of battery powered wireless lighting fixtures to turn the light sources on. The battery powered wireless lighting fixtures may be stair lights, spotlights, path lights, exit signs and lighting, stair well lights, floor lights, ceiling lights etc to provide lighting in an emergency situation.

US patent publication 2014/0312802 relates to systems and methods that provide for a power outage lighting management within an environment, comprising a power outage detection device adapted to detect power outage condition and to wirelessly transmit power outage indication data to a plurality of lighting systems within the environment. In embodiments, a wireless emergency lighting system may be controlled by a power outage module. In such an embodiment, battery powered wireless lighting fixtures containing a wireless receiver may be controlled by a power outage module such that upon detecting a disturbance in the power input, the power outage module may transmit a command to any number or type of battery powered wireless lighting fixtures to turn the light sources on. The battery powered wireless lighting fixtures may be stair lights, spotlights, path lights, exit signs and lighting, stair well lights, floor lights, ceiling lights etc to provide lighting in an emergency situation.

US patent publication 2014/0097758 relates to a wireless lighting module that includes a light source, a controller configured to control illumination of the light source, a connector configured to provide power to an external device, and a battery configured to supply power to light source, controller and connector. In embodiments of emergency wireless lighting devices, a system may be created including a battery backed LED Driver Module for LED fixtures containing a connection to external power, an integrated power source, a wireless receiver and the capability to drive the LED light source and a power outage module containing a power outage detector to detect a disruption in power and a wireless transmitter such that the power outage module may control the light source powered by the battery backed LED Driver Module via the power outage module.

US patent publication 2013/0342131 relates to a wireless power outage lighting system comprising one or more power change detection apparatuses and one or more wireless lighting modules where the system is implemented to allow management of multiple groups in the same area. In embodiments of emergency wireless lighting devices, a system may be created including a battery backed LED Driver Module for LED fixtures containing a connection to external power, an integrated power source, a wireless receiver and the capability to drive the LED light source and a power outage module containing a power outage detector to detect a disruption in power and a wireless transmitter such that the power outage module may control the light source powered by the battery backed LED Driver Module via the power outage module.

U.S. Pat. No. 8,994,276 relates to a power management system for a lighting circuit that includes a grid shifting controller that includes a processor and a connection to an external power source. In embodiments of emergency wireless lighting devices, a system may be created including a battery backed LED Driver Module for LED fixtures containing a connection to external power, an integrated power source, a wireless receiver and the capability to drive the LED light source and a power outage module containing a power outage detector to detect a disruption in power and a wireless transmitter such that the power outage module may control the light source powered by the battery backed LED Driver Module via the power outage module.

U.S. Pat. No. 9,089,016 relates to an autonomous shifting of at least a portion of a lighting load off an energy distribution grid. In embodiments of emergency wireless lighting devices, a system may be created including a battery backed LED Driver Module for LED fixtures containing a connection to external power, an integrated power source, a wireless receiver and the capability to drive the LED light source and a power outage module containing a power outage detector to detect a disruption in power and a wireless transmitter such that the power outage module may control the light source powered by the battery backed LED Driver Module via the power outage module.

U.S. Pat. No. 9,236,767 relates to providing intelligent power control in response to an external power interruption. In embodiments of emergency wireless lighting devices, a system may be created including a battery backed LED Driver Module for LED fixtures containing a connection to external power, an integrated power source, a wireless receiver and the capability to drive the LED light source and a power outage module containing a power outage detector to detect a disruption in power and a wireless transmitter such that the power outage module may control the light source powered by the battery backed LED Driver Module via the power outage module.

U.S. Pat. No. 8,764,242 relates to systems and methods that provide a power outage lighting management system within an environment comprising a power outage detection device. In embodiments of emergency wireless lighting devices, a system may be created including a battery backed LED Driver Module for LED fixtures containing a connection to external power, an integrated power source, a wireless receiver and the capability to drive the LED light source and a power outage module containing a power outage detector to detect a disruption in power and a wireless transmitter such that the power outage module may control the light source powered by the battery backed LED Driver Module via the power outage module.

U.S. Pat. No. 8,829,799 relates to an autonomous shifting of at least a portion of a lighting load of an energy distribution grid. In an embodiment, a wireless emergency lighting system, the battery powered wireless lighting fixtures consists of an RF ceiling light and an RF nightlight that are off grid and may receive transmission from a power outage module that contains an RF transmitter, plugs into a wall outlet and directly monitors AC power such that a detected condition that would require a switchover to emergency lighting, such as a power outage or disruption in power, would initiate a transmission to the RF ceiling light and RF nightlight to turn them on.

U.S. Pat. No. 8,519,566 relates to providing intelligent power control in response to an external power interruption. In an embodiment, a wireless emergency lighting system, the battery powered wireless lighting fixtures consists of an RF ceiling light and an RF nightlight that are off grid and may receive transmission from a power outage module that contains an RF transmitter, plugs into a wall outlet and directly monitors AC power such that a detected condition that would require a switchover to emergency lighting, such as a power outage or disruption in power, would initiate a transmission to the RF ceiling light and RF nightlight to turn them on.

U.S. Pat. No. 8,491,159 relates to providing a power outage lighting management within an environment, comprising a power outage detection device to detect a power outage condition and transmit it to a plurality of lighting systems. In an embodiment, a wireless emergency lighting system, the battery powered wireless lighting fixtures consists of an RF ceiling light and an RF nightlight that are off grid and may receive transmission from a power outage module that contains an RF transmitter, plugs into a wall outlet and directly monitors AC power such that a detected condition that would require a switchover to emergency lighting, such as a power outage or disruption in power, would initiate a transmission to the RF ceiling light and RF nightlight to turn them on.

U.S. Pat. No. 8,754,778 relates to an exit sign lighting retrofit system for a sign with a housing, an isolated power supply circuit mounted in said housing electrically coupled to a plurality of LED arrays connected in series said power supply providing power to the LED arrays; wherein each LED array contains a plurality of LEDs connected in parallel; and, a battery backup electrically coupled to the power supply in an manner where the battery supplies input power to the power supply when line voltage is unavailable.

U.S. Pat. No. 8,946,991 relates to a system for solid state lighting that if a power outage occurs, a power switch switches the AC power source for LED driver from grid power to inverter. If a power outage occurs, the drop out detection function signals LED controller to operate under a ‘ power down’ mode which begins to dim lights according to a pre-programmed schedule. Power detection function also signals battery switch to connect DC power from battery to inverter.

US patent publication 2005/0259416 relates to a dual lighting system including an LED illuminator, and a lamp positioned in proximity to the LED illuminator. The dual lighting system further comprises a battery-backup module for the LED illuminator, wherein the battery backup module provides power to the LED illuminator if there is a power outage.

US patent publication 2008/0266849 relates to a power conveyor added to a fluorescent light to convert fluorescent lighting to LED lighting utilizing existing ballast technology. Any and/or all of the embodiments may be used with a battery “back-up” system, which may include one or more batteries that provide power to illuminate the LEDs in the event of a power outage. The power converter is compatible for the battery backup concept and remains a viable alternative when ballasts are converted from AC to DC power using the power converter. This type of battery back-up system can be installed when the fluorescent fixture is retrofit using the power converter. In some embodiments, the methods may include the step of adding a battery back-up system as part of the retrofitting process.

US patent publication 2013/0335944 relates to a cool tube LED lighting. The lighting comprises AC power, DC power source and from an on-board battery backup, and can be used as an emergency light source: The device will operate as emergency lighting with the onboard battery backup. The device is comprises an AC-DC power/LED pump and battery backup modules that are field replaceable.

US patent publication 2014/0320011 relates to an emergency lighting system having a self-test capability; the system comprising: at least one circuit that includes a plurality of emergency LED lighting fixtures; a central battery system that provides direct current voltage as normal power and direct current voltage backup power to the circuit of emergency LED lighting fixtures; the central battery system including at least one battery that is adapted to supply direct current voltage to the circuit when line power to the central battery system is off; a transfer switch configured to connect the battery to the circuit when the line power is off, and a control board that performs tests of the battery capacity, the operation of the LED lighting fixtures.

US patent publication 2014/0139122 relates to the design of a multi-state power management system that facilitates switching to battery backup power upon identifying a power outage and further controlling the intensity level of a load (e.g., a light source) such that the light run time meets a minimum required run time. The system may be designed and configured to identify a power outage and a battery status based on the voltage at a voltage input of the lighting device.

US patent publication 2015/0108896 relates to a system for solid state lighting. If a power outage occurs, power switch switches the AC power source for LED driver from grid power to inverter. Drop out detection function monitors grid power at AC switch. If a power outage occurs, the drop out detection function signals LED controller is operated under a ‘ power down’ mode which begins to dim lights according to a pre-programmed schedule. Power detection function also signals battery switch to connect DC power from battery to inverter. Inverter is kept ‘on’ and ‘ idle’ by power from DC power supply. This allows the inverter to provide AC power to AC switch more quickly than if it were powered down and required a cold start from battery power in the event of power outage.

US patent publication 2015/0021988 relates to a hybrid power architecture for lighting system that physically separates the conversion of AC-DC constant voltage power from the conversion of DC-DC constant current needed to drive the LEDs. The hybrid power architecture comprises a power converter to generate DC volt power, a battery backup unit for providing backup in the event of power failure and control architecture for controlling the intensity of the lighting system.

Building codes require that its lights require a backup. Fixtures need a lumen output of 90 minutes.

### SUMMARY OF THE INVENTION

The present invention relates to a lighting fixture that accepts a backup battery system and can be installed in the field. It is an object of the present invention for the fixture to be an LED lighting fixture. It is an object of the present invention for the device to further comprise an indicator light which displays certain color light when the battery is charging and when there is no power and the backup battery is required. It is an object of the present invention for the device to comprise a button that tests that the battery backup system is functional. It is an object of the present invention for a plate to cover the openings where the test button and indicator light are to be installed when the battery backup system is not installed.

It is an object of the present invention for the fixture to comprise an off-the-shelf emergency battery back-up ready fixture. It is an object of the present invention for the battery backup to comprise a standalone one piece unit. It is an object of the present invention for the battery backup to comprise a multitude of shapes for use in ceiling and wall mounted lighting fixtures.

It is an object of the present invention to produce fixtures with the capability of, easy in-field modification at the time of installation, or as part of the original manufacturing process, to use the device of the present invention. It is an object of the present invention for the fixture to be flush mounted to the wall. It is an object of the present invention for the fixture to be mounted to the ceiling. It is an object of the present invention for the battery system to use a power inverter. It is an object of the present invention for the battery backup to comprise lithium battery or batteries.

It is an object of the present invention for the battery to feed the inverter to run the LED light engine.

It is an object of the present invention to have an fixture that is designed to be ready to accept an emergency battery backup system that an electrician can simply add on to the fixture in minutes.

It is an object of the present invention for the device to comprise an LED light engine mounting hole. It is an object of the present invention for the device to comprise a battery compartment access cover. It is an object of the present invention for the device to comprise a removable plate to conceal holes for a non-battery unit.

It is an object of the present invention for the emergency backup battery system to be mounted into the fixture. It is an object of the present invention for the backup battery system to be mounted by snapping into the fixture.

It is an object of the present invention for the fixture to be battery backup ready with proper holes and connections. It is an object of the present invention for the device to have access to replace batteries below a removable LED light engine. It is an object of the present invention for the device to comprise a Li ion battery compartment. It is an object of the present invention for the device to comprise an LED charging indicator light.

It is an object of the present invention for the battery backup system to accept a plug in connection from the light engine. The system would bypass the main system voltage, and the LED fixture would get power from the battery backup. When the power is restored the system works with the main power from the electrical box, it bypasses the battery backup.

The battery backup system includes battery backup, the indicator light and the test button to be installed into the fixture.

It is an object of the present invention to have stamped openings in the fixture so that the batteries can be replaced without having to remove the fixture from where it is mounted.

It is an object of the present invention for the device to allow for an aftermarket snap or screw in installation of the battery backup.

### BRIEF DESCRIPTION OF THE DRAWINGS

FIG. 1 is a bottom view of an embodiment of the present invention showing the hole pattern for the light engine.

FIG. 2a is a side view of an embodiment of the present invention showing the plate.

FIG. 2b is a top view of an embodiment of the present invention showing the plate.

FIG. 3 is a bottom view of an embodiment of the present invention showing the fixture and the battery backup.

FIG. 4 is a bottom view of an embodiment of the present invention showing the fixture, LED light source and battery backup.

FIG. 5a is a top view of an embodiment of the present invention showing the LED light engine.

FIG. 5b is a side view of an embodiment of the present invention showing the LED light engine.

FIG. 5c is a side view of an embodiment of the present invention showing the LED light engine.

FIG. 5d is a top view of an embodiment of the present invention showing the LED light engine.

FIG. 6a is a top view of an embodiment of the present invention showing the LED emergency module.

FIG. 6b is a side view of an embodiment of the present invention showing the LED emergency module.

FIG. 6c is a side view of an embodiment of the present invention showing the LED emergency module.

FIG. 6d is a top view of an embodiment of the present invention showing the LED emergency module.

### DETAILED DESCRIPTION OF THE INVENTION

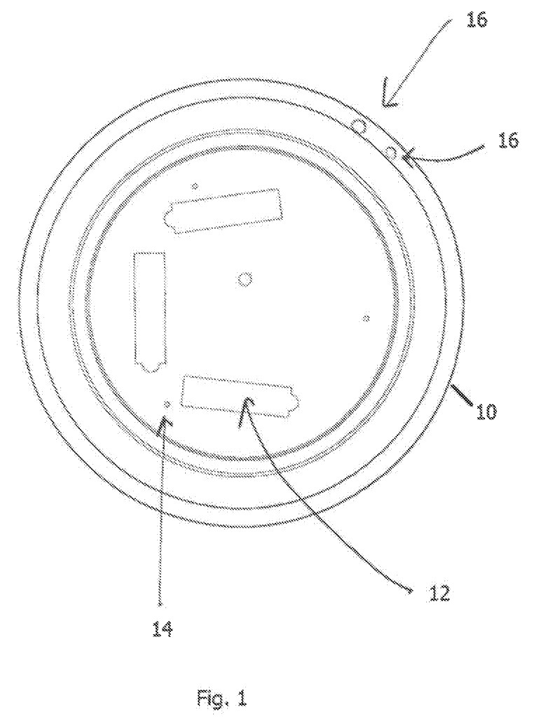

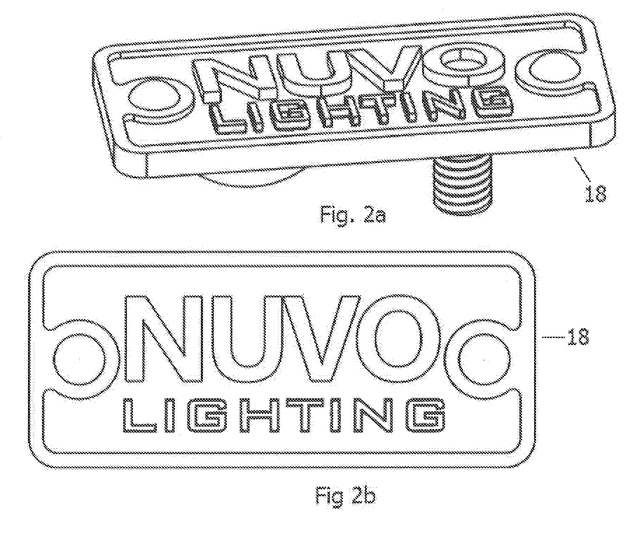

FIG. 1 shows a hole pattern for a light engine only and a backup battery module. The device 10 has a battery compartment access cover 12, and a LED disc mounting hole 14. The device 10 further has holes 16, which are covered by a plate 16 shown in FIG. 2. The holes 16 are for a test button and an LED charging indication light.

FIGS. 2a and 2b show a plate 18, which is used to cover the holes 16, when the backup battery is not being assembled to the lighting fixture.

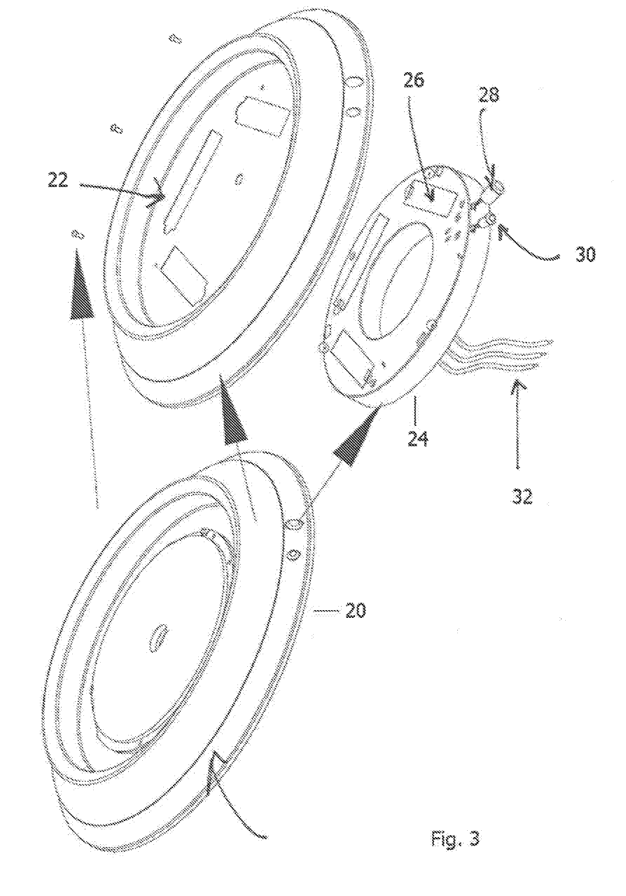

FIG. 3 shows the LED fixture battery backup ready device 20 having holes and connections, which has the access 22 to replace the batteries after the LED light disc is removed. The LED battery backup 24 has the Lithium battery component, plug in connection test button 28, and LED charging indicator light 30. Also shown are power supply lead wires 32 for three wire switched applications.

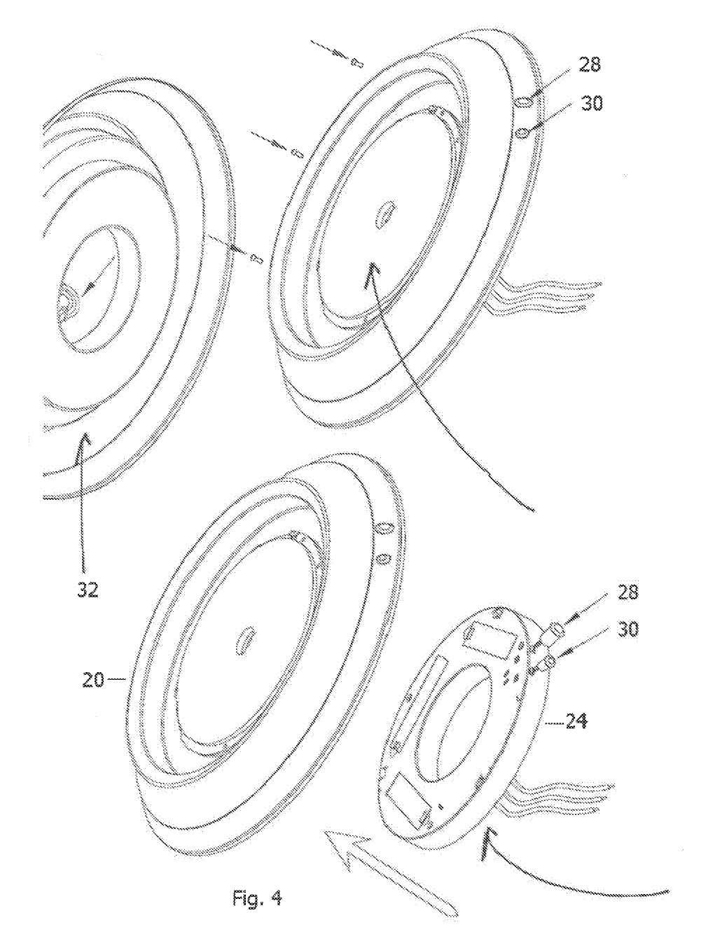

FIG. 4 shows the LED fixture battery backup device 20 showing a ceiling side of a fixture pan 32. Also shown is the LED disc light source 34, the test button 28 and the LED charging indicator light 30. The battery backup 24 can be installed into the LED emergency ready fixture system as a snap in or screw in installation.

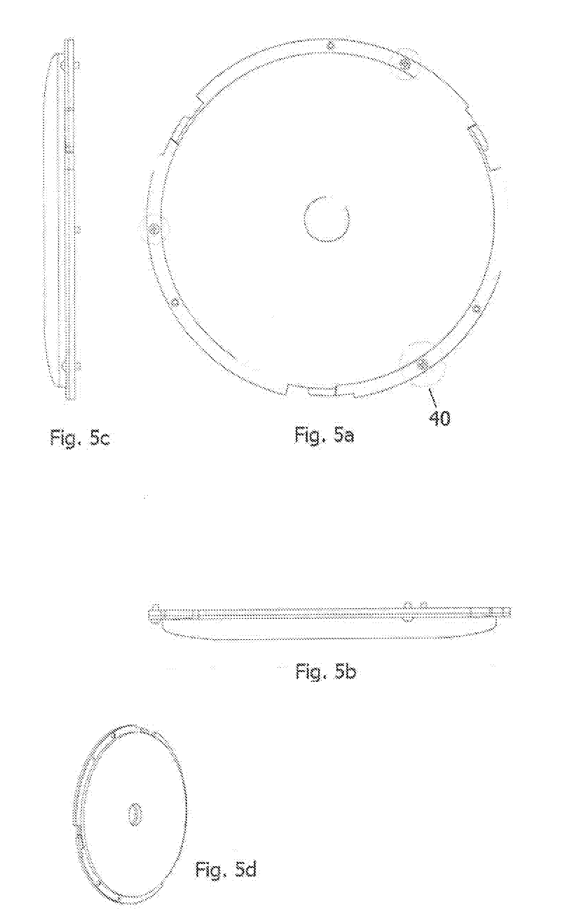

FIG. 5a-5d shows the LED light engine having screw locations 40.

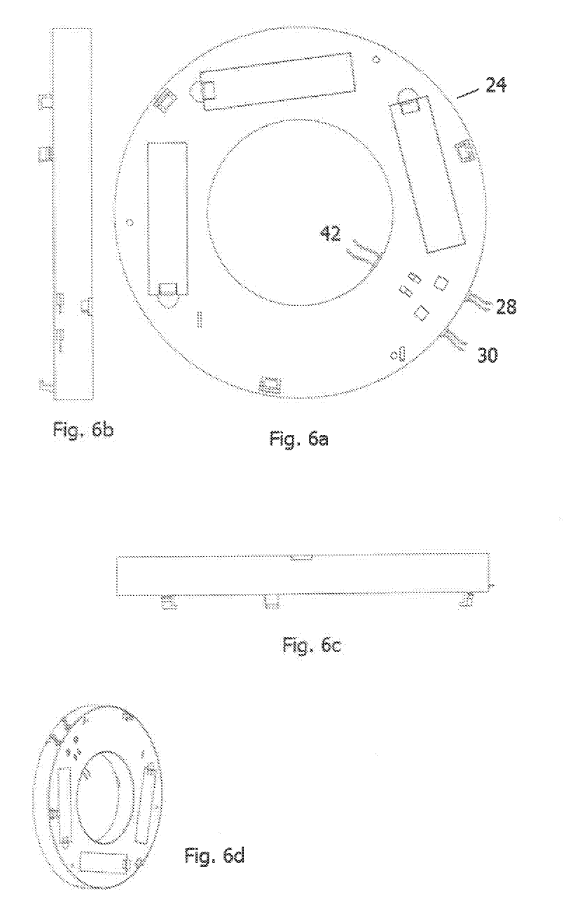

FIGS. 6a-6d shows the LED emergency module, battery backup 24. FIG. 6 shows the battery backup 24 having the test button 28, LED charging indicator light 30 and LED cables 42.

1. A device for a battery backup system comprising:
a lighting fixture;
an LED light source;
said LED light source accepting said battery backup system;
said battery backup system comprising batteries, an indicator light and a test button, battery compartment access covers, battery compartments;
said batteries feeding an inverter to run said LED light source;
said battery system plugged into said light source.

2. The device of claim 1 wherein said device is installed in the field.

3. The device of claim 1 wherein a plate covers holes where said indicator light and said test button are found when said battery backup system is not installed.

4. The device of claim 1 wherein said lighting fixture is an off-the-shelf fixture.

5. The device of claim 1 wherein said battery backup system comprises a module utilizing an inverter.

6. The device of claim 1 wherein said battery backup system comprises a donut.

7. The device of claim 1 wherein said lighting fixture is mounted to a wall.

8. The device of claim 1 wherein said lighting fixture is mounted to a ceiling.

9. The device of claim 1 wherein said batteries are lithium battery or batteries.

10. The device of claim 1 wherein said lighting fixture comprises an LED light engine mounting hole.

11. The device of claim 1 wherein said backup battery system is mounted into said fixture.

12. The device of claim 1 wherein said battery backup system is mounted by snapping said battery backup system into said fixture.

13. The device of claim 1 wherein said lighting fixture comprises holes and connections for said battery backup system.

14. The device of claim 1 further comprising access to replace said batteries below a removable LED light engine.

15. The device of claim 1 wherein said device would engage and get power from said battery backup when emergency power is required.

16. The device of claim 1 wherein said device works with main voltage from an electrical box, and bypasses said battery backup when emergency power is not required.

17. The device of claim 1 wherein said fixture has stamped openings in said fixture so that said batteries are replaced without having to remove said fixture from where it is mounted.

18. The device of claim 1 further comprising power supply lead wires for switched applications.
